(19) United States
(12) Patent Application Publication
(10) Pub. No.: US 2014/0059418 A1
(43) Pub. Date: Feb. 27, 2014

(54) MULTIMEDIA ANNOTATION EDITING SYSTEM AND RELATED METHOD AND COMPUTER PROGRAM PRODUCT

(71) Applicant: Realtek Semiconductor Corp., Hsinchu (TW)

(72) Inventors: Siu-Leong YU, Hsinchu County (TW); Chin Huang HSU, Hsinchu City (TW); Shih-Chun WEI, Hsinchu City (TW); Chen MA, San Jose, CA (US)

(73) Assignee: Realtek Semiconductor Corp., Hsinchu (TW)

(21) Appl. No.: 13/974,800

(22) Filed: Aug. 23, 2013

Related U.S. Application Data
(60) Provisional application No. 61/813,652, filed on Apr. 19, 2013.

(30) Foreign Application Priority Data
Aug. 24, 2012 (TW) 101130868
Aug. 28, 2012 (TW) 101131261

(51) Int. Cl. G06F 17/24

(52) U.S. Cl. CPC G06F 17/241
USPC 715/230

(57) ABSTRACT

A multimedia annotation editing system includes: a web server for providing an annotation editing page; and a webpage display device for communicating with the web server via internet, and for receiving and displaying the annotation editing page. If the webpage display device received an annotation template selection command, the webpage display device displays a preview of a target annotation template in an annotation preview area. The webpage display device modifies parameters of the target annotation template according to a user's manipulation and displays a modified preview of the target annotation template in the annotation preview area. The webpage display device transmits modified parameters of the target annotation template to the web server so that the web server generates a multimedia annotation according to the modified parameters of the target annotation template.

### CROSS-REFERENCE TO RELATED APPLICATIONS

This application claims the benefit of priority to Patent Application No. 101130868, filed in Taiwan on Aug. 24, 2012; the entirety of which is incorporated herein by reference for all purposes.

This application claims the benefit of priority to Patent Application No. 101131261, filed in Taiwan on Aug. 28, 2012; the entirety of which is incorporated herein by reference for all purposes.

This application claims the benefit of priority to U.S. Provisional Application Ser. No. 61/813,652, filed on Apr. 19, 2013; the entirety of which is incorporated herein by reference for all purposes.

### BACKGROUND

The disclosure generally relates to a multimedia interaction technique and, more particularly, to a multimedia annotation editing system and related method and computer program products.

As the progress of the internet applications, there are more and more video-providing websites allowing users to browse or download videos. In order to increase the level of interaction between video viewers, some video-providing websites allow the video viewers to write annotations to the content of videos, so that other video viewers may see the annotations written by other people while watching the videos.

However, unless the video viewers have professional multimedia editing software and have received professional training on multimedia content producing, they use only plain texts to present the content of their annotations. Accordingly, up to now most video annotations are presented in the format of plain texts. Video annotations presented by texts are not easy to attract the video viewer's attention, and are thus difficult to increase the level of interaction between the video viewers.

### SUMMARY

An example embodiment of a multimedia annotation editing system is disclosed, comprising: a web server, configured to operably provide an annotation editing page comprising multiple annotation templates; and a webpage display device, configured to operably communicate with the web server through an internet, and to operably receive and display the annotation editing page transmitted from the web server through the internet; wherein when the webpage display device displays the annotation editing page, if an annotation template selection command corresponding to a target annotation template of the multiple annotation templates is received by the webpage display device, the webpage display device displays a preview of the target annotation template in an annotation preview area of the annotation editing page; wherein the webpage display device further modifies at least one of following parameters of the target annotation template according to a user's manipulation: a quantity of text frames in the target annotation template; a size of a text frame in the target annotation template; a position of a text frame in the target annotation template; a shape of an object in the target annotation template; a position of an object in the target annotation template; a size of an object in the target annotation template; a rotation angle of an object in the target annotation template; a color of an object in the target annotation template; a lasting time on the screen of an object in the target annotation template; a moving speed of an object in the target annotation template; a moving direction of an object in the target annotation template; a moving path of an object in the target annotation template; a change speed of an animation in the target annotation template; a lasting time of vibration of an object in the target annotation template; and a lasting time of vibration of the target annotation template; wherein the webpage display device displays a modified preview of the target annotation template in the annotation preview area, and configures a start time and an end time of a multimedia annotation according to the user's manipulation; wherein the webpage display device transmits the start time, the end time, and modified parameters of the target annotation template to the web server, the web server generates the multimedia annotation according to the modified parameters of the target annotation template, and establishes and stores a timing correlation between the multimedia annotation and a target video according to the start time and the end time.

An example embodiment of multimedia annotation editing method for use in a multimedia annotation editing system is disclosed. The multimedia annotation editing system comprises a web server and a webpage display device, and the webpage display device comprises a communication circuit, a display device, a speaker, an input device, and a control circuit. The method comprises: utilizing the communication circuit to receive an annotation editing page comprising multiple annotation templates transmitted from the transmission circuit through an internet; utilizing the display device to display the annotation editing page; when the display device displays the annotation editing page, utilizing the display device to display a preview of a target annotation template of the multiple annotation templates in an annotation preview area of the annotation editing page if an annotation template selection command corresponding to the target annotation template is received by the input device; modifying at least one of following parameters of the target annotation template according to a user's manipulation to the input device: a quantity of text frames in the target annotation template; a size of a text frame in the target annotation template; a position of a text frame in the target annotation template; a shape of an object in the target annotation template; a position of an object in the target annotation template; a size of an object in the target annotation template; a rotation angle of an object in the target annotation template; a color of an object in the target annotation template; a lasting time on the screen of an object in the target annotation template; a moving speed of an object in the target annotation template; a moving direction of an object in the target annotation template; a moving path of an object in the target annotation template; a change speed of an animation in the target annotation template; a lasting time of vibration of an object in the target annotation template; and a lasting time of vibration of the target annotation template; utilizing the display device to display a modified preview of the target annotation template in the annotation preview area; configuring a start time and an end time of a multimedia annotation according to the user's manipulation to the input device; and utilizing the communication circuit to transmit the start time, the end time, and modified parameters of the target annotation template to the web server, so that the web server generates the multimedia annotation according to the modified parameters of the target annotation template and establishes and stores a timing correlation between the multimedia annotation and a target video according to the start time and the end time.

An example embodiment of a computer program product is disclosed. The computer program product is stored in a non-transitory storage device of a webpage display device in a multimedia annotation editing system. When the computer program product is executed by a control circuit of the webpage display device, the computer program product enables the webpage display device to perform a multimedia annotation editing operation, wherein the multimedia annotation editing system comprises a web server and the webpage display device, and the webpage display device comprises a communication circuit, a display device, a speaker, an input device, and the control circuit. The computer program product comprises: a receiving module, for utilizing the communication circuit to receive an annotation editing page comprising multiple annotation templates transmitted from the web server through an internet; a display module, for utilizing the display device to display the annotation editing page; a setting module; and a transmitting module; wherein when the display device displays the annotation editing page, if an annotation template selection command corresponding to a target annotation template of the multiple annotation templates is received by the input device, the display module utilizes the display device to display a preview of the target annotation template in an annotation preview area of the annotation editing page; wherein the setting module further modifies at least one of following parameters of the target annotation template according to a user's manipulation to the input device: a quantity of text frames in the target annotation template; a size of a text frame in the target annotation template; a position of a text frame in the target annotation template; a shape of an object in the target annotation template; a position of an object in the target annotation template; a size of an object in the target annotation template; a rotation angle of an object in the target annotation template; a color of an object in the target annotation template; a lasting time on the screen of an object in the target annotation template; a moving speed of an object in the target annotation template; a moving direction of an object in the target annotation template; a moving path of an object in the target annotation template; a change speed of an animation in the target annotation template; a lasting time of vibration of an object in the target annotation template; and a lasting time of vibration of the target annotation template; wherein the display module utilizes the display device to display a modified preview of the target annotation template in the annotation preview area, and the setting module configures a start time and an end time of a multimedia annotation according to the user's manipulation to the input device; wherein the transmitting module utilizes the communication circuit to transmit the start time, the end time, and modified parameters of the target annotation template to the web server, so that the web server generates the multimedia annotation according to the modified parameters of the target annotation template and establishes and stores a timing correlation between the multimedia annotation and a target video according to the start time and the end time.

### BRIEF DESCRIPTION OF THE DRAWINGS

FIG. 1 shows a simplified functional block diagram of a multimedia annotation editing system according to one embodiment of the present disclosure.

FIG. 2 shows a simplified schematic diagram of functional modules of a computer program product in a webpage display device of FIG. 1 according to one embodiment of the present disclosure.

FIGS. 3 and 4 collectively show a simplified flowchart illustrating a multimedia annotation editing method according to one embodiment of the present disclosure.

FIG. 5 shows a simplified schematic diagram of a video selection page according to one embodiment of the present disclosure.

FIG. 6 shows a simplified schematic diagram of a video playback page according to one embodiment of the present disclosure.

FIGS. 7˜12 show simplified schematic diagrams of an annotation editing page in different stages according to one embodiment of the present disclosure.

FIG. 13 shows a simplified schematic diagram of an annotation editing page according to another embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

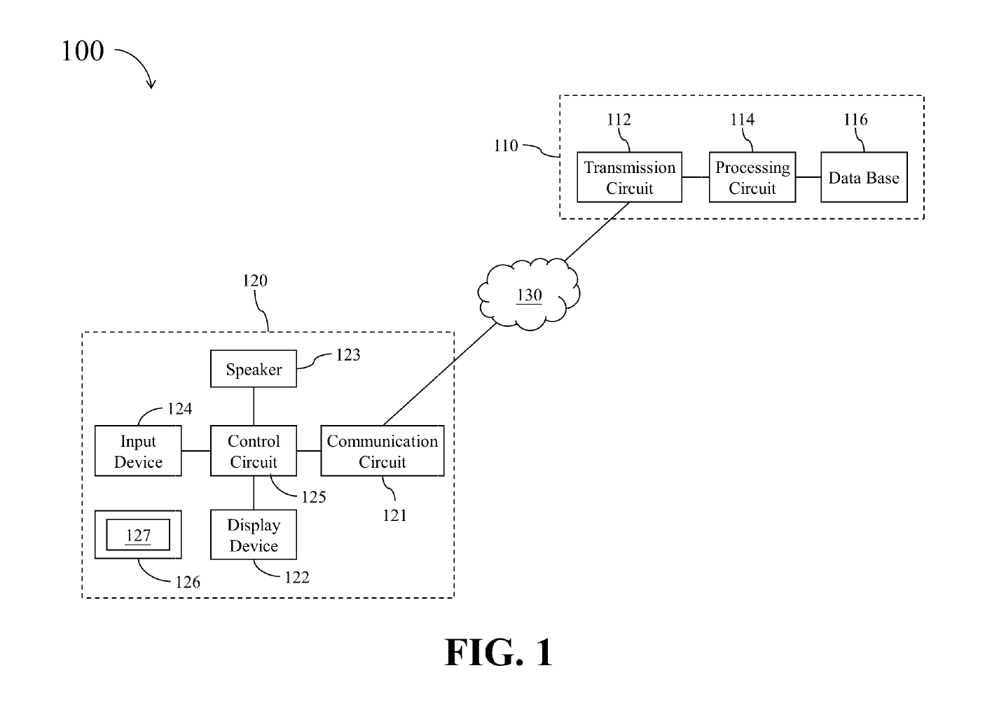

FIG. 1 shows a simplified functional block diagram of a multimedia annotation editing system 100 according to one embodiment of the present disclosure. The multimedia annotation editing system 100 comprises a web server 110 and a webpage display device 120. The web server 110 is configured to operably provide a video selection page, a video playback page, and an annotation editing page comprising multiple annotation templates to the webpage display device 120 through an internet 130. The webpage display device 120 is configured to operably communicate with the web server 110 through the internet 130, and to operably receive and display the video selection page, the video playback page, and the annotation editing page transmitted from the web server 110 through the internet 130.

When the webpage display device 120 displays the annotation editing page, if an annotation template selection command corresponding to a target annotation template of the multiple annotation templates is received by the webpage display device 120, the webpage display device 120 displays a preview of the target annotation template in an annotation preview area of the annotation editing page. The webpage display device 120 may modify parameters of the target annotation template according to a user's manipulation, and may display a modified preview of the target annotation template in the annotation preview area for the user to acknowledge. The webpage display device 120 may further configure a start time and an end time according to the user's manipulation. Afterward, the webpage display device 120 transmits the start time, the end time, and modified parameters of the target annotation template to the web server 110 through the internet 130. The web server 110 generates a multimedia annotation according to the modified parameters of the target annotation template, and establishes and stores a timing correlation between the multimedia annotation and a selected target video according to the start time and the end time.

The term “multimedia annotation” used throughout the description and the claims refers to various annotation data consisting of at least two of texts, graphs, images, and audio data. Therefore, the multimedia annotation is much richer in the way of presenting its content than the traditional annotation consisting of only texts (hereinafter, text annotation), and is thus able to attract more attention of other users.

In the embodiment of FIG. 1, the web server 110 comprises a transmission circuit 112, a processing circuit 114, and a data base 116. The webpage display device 120 comprises a communication circuit 121, a display device 122, a speaker 123, an input device 124, a control circuit 125, and a memory 126, wherein the memory 126 is stored with a computer program product 127.

In the web server 110, the transmission circuit 112 is configured to operably transmit the video selection page, the video playback page, and the annotation editing page to the webpage display device 120 through the internet 130, and to operably receive the start time, the end time, and the modified parameters of the target annotation template transmitted from the webpage display device 120. The processing circuit 114 is coupled with the transmission circuit 112, and is configured to operably control operations of the transmission circuit 112, generate the multimedia annotation according to the modified parameters of the target annotation template, and establish a timing correlation between the multimedia annotation and the target video according to the start time and the end time. The data base 116 is coupled with the processing circuit 114, and is configured to store the multimedia annotation and the timing correlation between the multimedia annotation and the target video.

In the webpage display device 120, the communication circuit 121 is configured to operably receive the video selection page, the video playback page, and the annotation editing page transmitted from the transmission circuit 112. The display device 122 is configured to operably display the video selection page, the video playback page, and the annotation editing page. The input device 124 is configured to operably receive the annotation template selection command The control circuit 125 is coupled with the communication circuit 121, the display device 122, the speaker 123, the input device 124, and the memory 126. When the display device 122 displays the annotation editing page, if the annotation template selection command is received by the input device 124, the control circuit 125 controls the display device 122 to display the preview of the target annotation template in the annotation preview area of the annotation editing page. The control circuit 125 further modifies the parameters of the target annotation template and configures the start time and the end time of the multimedia annotation according to the user's manipulation to the input device 124, and controls the display device 122 to display a modified preview of the target annotation template in the annotation preview area. The control circuit 125 further controls the communication circuit 121 to transmit the start time, the end time, and the modified parameters of the target annotation template to the transmission circuit 112.

Each of the aforementioned transmission circuit 112 and communication circuit 121 may be realized with a wired network interface, a wireless network interface, or a hybrid circuit integrated with the above two interfaces. Each of the aforementioned processing circuit 114 and control circuit 125 may be realized with one or more processor units. The aforementioned input device 124 may be realized with a touch screen, a touch pad, a keyboard, a computer mouse, a voice control device, or a combination of the aforementioned devices. Furthermore, the display device 122 may be realized with any display screen or projector, and may be integrated with the input device 124 into a touch screen.

In practice, the web server 110 may be realized with a single server, or may be realized with a combination of multiple servers located in the same geographical area or located in different geographical areas. The webpage display device 120 may be realized with any device capable of connecting to the internet and capable of displaying web pages, such as a computer (e.g., a tablet computer, a notebook computer, or a netbook computer), a TV, an electronic book, a hand-held game console, or a home theater system. For convenience of illustration, other elements in the web server 110 and the webpage display device 120 and their connection relationship are not shown in FIG. 1.

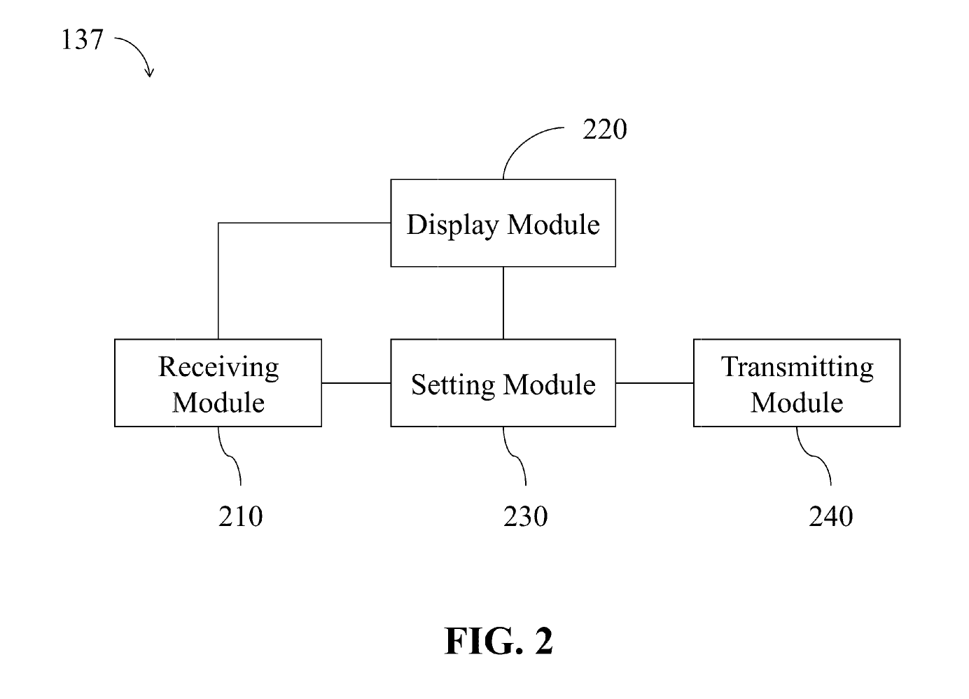

The computer program product 127 in the aforementioned webpage display device 120 may be realized with one or more application program modules. For example, FIG. 2 shows a simplified schematic diagram of functional modules of the computer program product 127 in FIG. 1 according to one embodiment of the present disclosure. In this embodiment, the computer program product 127 comprises a receiving module 210, a display module 220, a setting module 230, and a transmitting module 240.

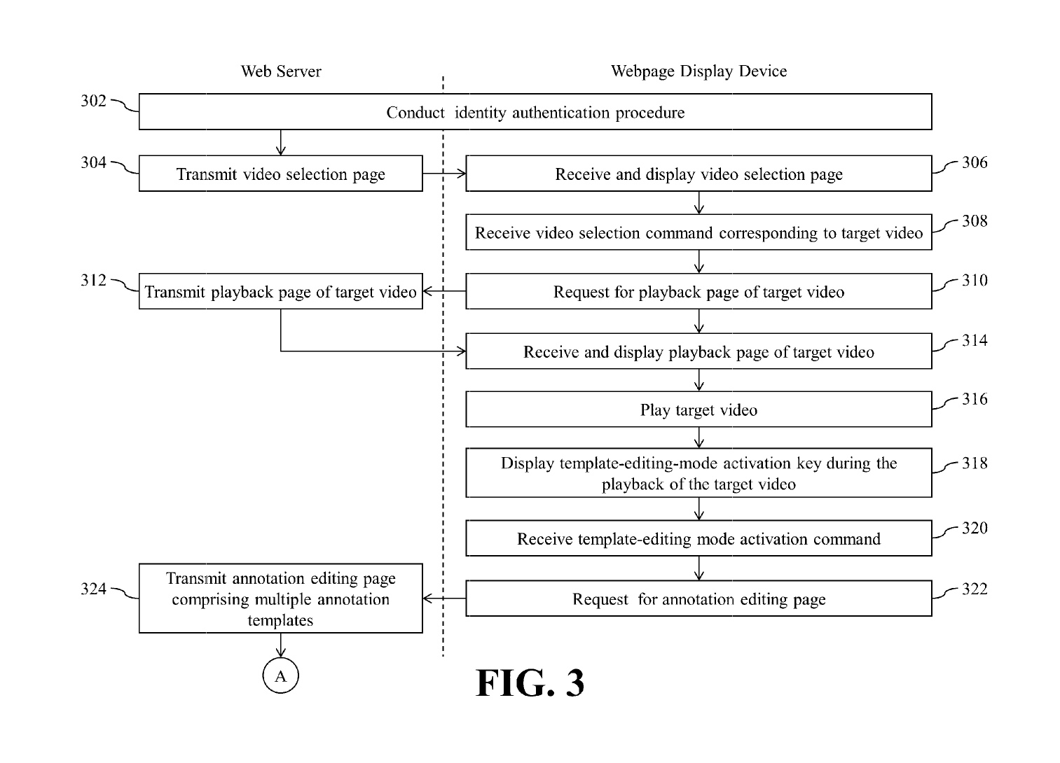

The operations of the multimedia annotation editing system 100 will be further described in the following by reference to FIG. 3 through FIG. 12.

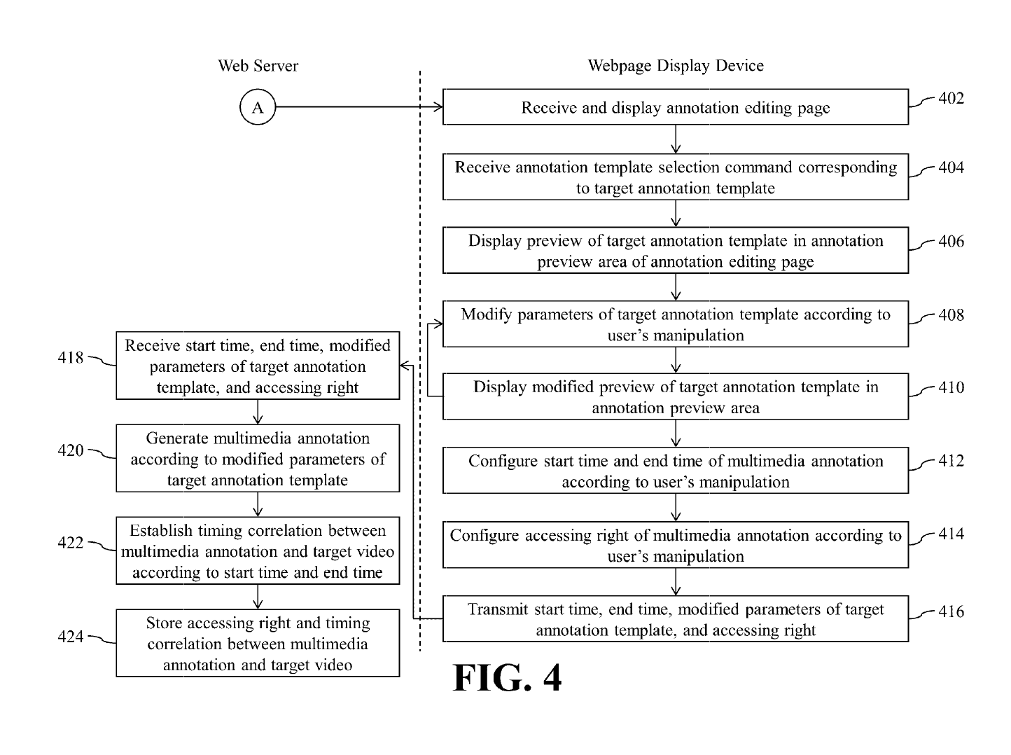

FIGS. 3 and 4 collectively show a simplified flowchart illustrating a multimedia annotation editing method according to one embodiment of the present disclosure. In the flowchart of FIGS. 3 and 4, operations within a column under the name of a specific device are operations to be performed by the specific device. For example, operations within a column under the label “web server” are operations to be performed by the web server 110, and operations within a column under the label “webpage display device” are operations to be performed by the webpage display device 120.

When performing the multimedia annotation editing method illustrated in the flowchart of FIGS. 3 and 4, the control circuit 125 of the webpage display device 120 executes the computer program product 127 in the memory 126 to enable the webpage display device 120 to perform a multimedia playback operation comprising some or all operations within the corresponding column.

In the operation 302, the webpage display device 120 may communicate with the web server 110 via the internet 130 according to the user's manipulation to conduct an identity authentication procedure, so that the web server 110 could confirm the identity of the user of the webpage display device 120.

In the operation 304, the processing circuit 114 of the web server 110 controls the transmission circuit 112 to transmit a video selection page to the webpage display device 120 through the internet 130.

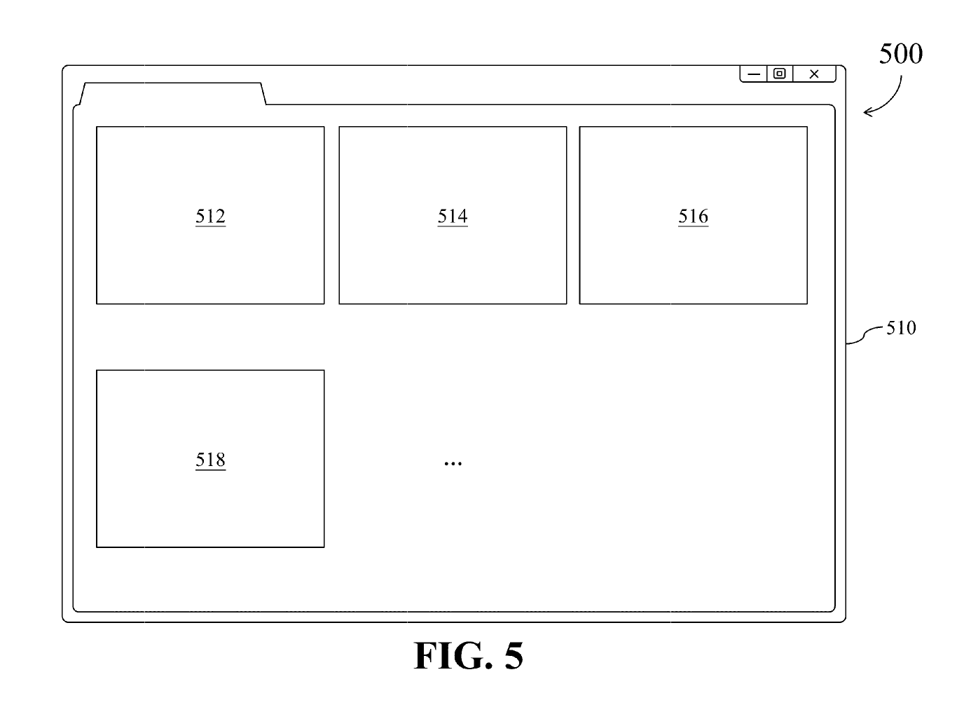

In the operation 306, the communication circuit 121 of the webpage display device 120 receives the video selection page transmitted from the transmission circuit 112, and the control circuit 125 controls the display device 122 to display the video selection page. For example, FIG. 5 shows a simplified schematic diagram of a video selection page 500 according to one embodiment of the present disclosure. The video selection page 500 comprises a display area 510. The display area 510 may be a window area of an application program (e.g., a web page browser). In this embodiment, the control circuit 125 controls the display device 122 to display multiple representative images of multiple videos (e.g., representative images 512, 514, 516, and 518 shown in FIG. 5) in the display area 510 for the user to select.

The user may select one target video of the multiple videos by clicking one of the multiple representative images displayed in the display area 510, such as a video corresponding to the representative image 514. At this moment, the input device 124 performs the operation 308 to receive a video selection command corresponding to the target video.

In the operation 310, the control circuit 125 of the webpage display device 120 controls the communication circuit 121 to transmit a playback page request to the web server 110, so as to request the web server 110 to provide a playback page of the target video.

In the operation 312, the processing circuit 114 of the web server 110 controls the transmission circuit 112 to transmit the playback page of the target video to the webpage display device 120 through the internet 130.

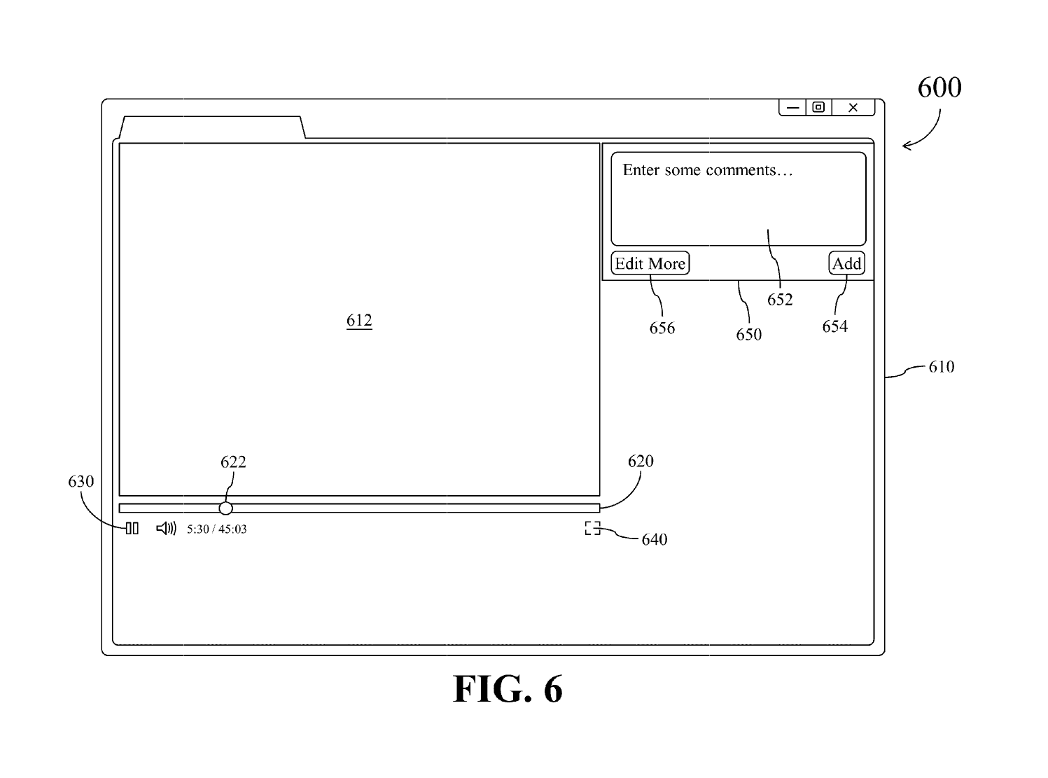

In the operation 314, the communication circuit 121 of the webpage display device 120 receives the playback page of the target video transmitted from the transmission circuit 112, and the control circuit 125 controls the display device 122 to display the playback page of the target video. For example, FIG. 6 shows a simplified schematic diagram of a video playback page 600 according to one embodiment of the present disclosure. The video playback page 600 comprises a display area 610. The display area 610 may be a window area of an application program (e.g., a web page browser).

When a playback command issued by the user is received by the input device 124, the control circuit 125 performs the operation 316 to control the display device 122 and the speaker 123 to play the video and audio content of the target video. In this embodiment, the display device 122 displays the target video in a partial region 612 within the display area 610, and displays a progress bar 620, a pause key 630, and a full-screen-mode key 640 in the display area 610. The progress bar 620 comprises a progress indicator 622 for indicating the current playback time of the target video. The user may click the play/pause key 630 to pause or resume the playback of the target video. When the user clicks the full-screen-mode key 640, the control circuit 125 controls the display device 122 to switch to a full-screen mode.

In practice, the video and audio content of the target video may be stored in the data base 116 of the web server 110 in advance, and may be transmitted to the web page display device 120 from the web server 110 when requested by the webpage display device 120.

Alternatively, the video and audio content of the target video may be stored in any other video server (not shown) in advance, and may be transmitted to the webpage display device 120 from the video server when requested by the webpage display device 120.

Additionally, during the playback of the target video, the control circuit 125 further performs the operation 318 to control the display device 122 to display an annotation input block 650 in the display area 610. In the embodiment of FIG. 6, the annotation input block 650 comprises a text input area 652, a confirmation key 654, and a template-editing-mode activation key 656. In other words, the operations 316 and 318 may be performed simultaneously.

In this embodiment, if the user only wants to compose a traditional text annotation, the user may directly input related comments or remarks into the text input area 652. Then, when the user clicks the confirmation key 654, the control circuit 125 controls the communication circuit 121 to transmit the text annotation inputted by the user to the web server 110 through the internet 130. Then, the transmission circuit 112 of the web server 110 receives the text annotation transmitted from the webpage display device 120, and the processing circuit 114 establishes a correlation between the text annotation and the target video, and stores the correlation between the text annotation and the target video in the data base 116.

If the user wants to create a multimedia annotation with much richer content, the user may click the template-editing-mode activation key 656 in the video playback page 600 to issue a template-editing mode activation command At this moment, the receiving module 210 of the computer program product 127 performs the operation 320 to utilize the input device 124 of the webpage display device 120 to receive the template-editing mode activation command.

In the operation 322, the transmitting module 240 of the computer program product 127 utilizes the communication circuit 121 to transmit an editing page request to the transmission circuit 112 of the web server 110 to request the web server 110 to provide an annotation editing page.

In the operation 324, the processing circuit 114 of the web server 110 controls the transmission circuit 112 to transmit an annotation editing page comprising multiple annotation templates to the webpage display device 120 through the internet 130.

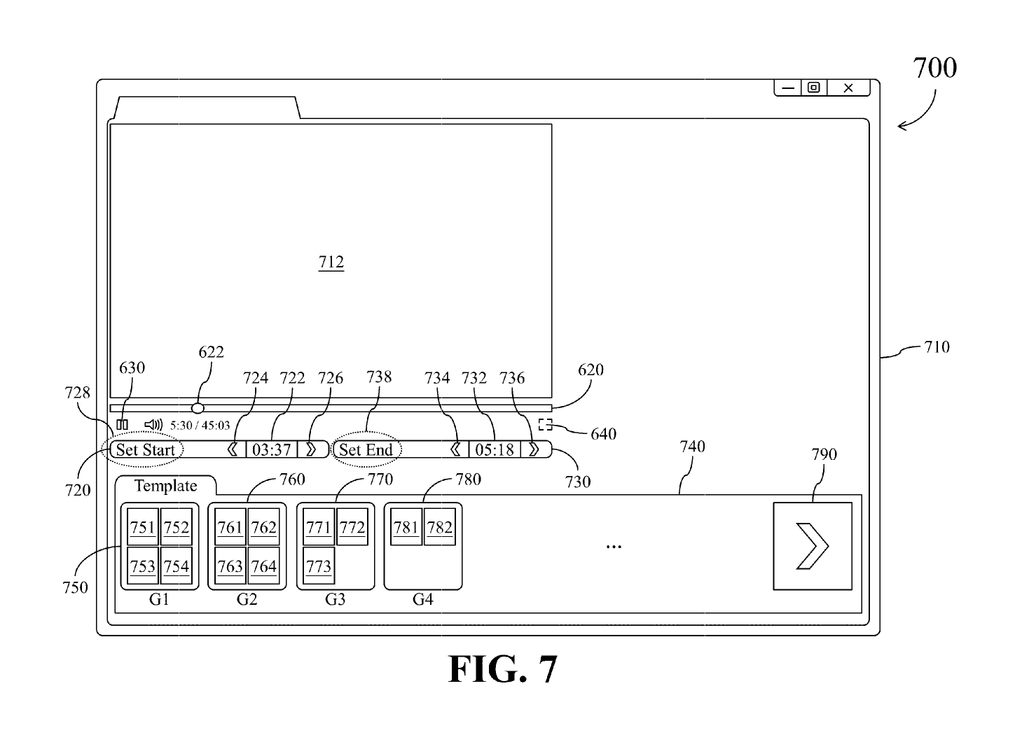

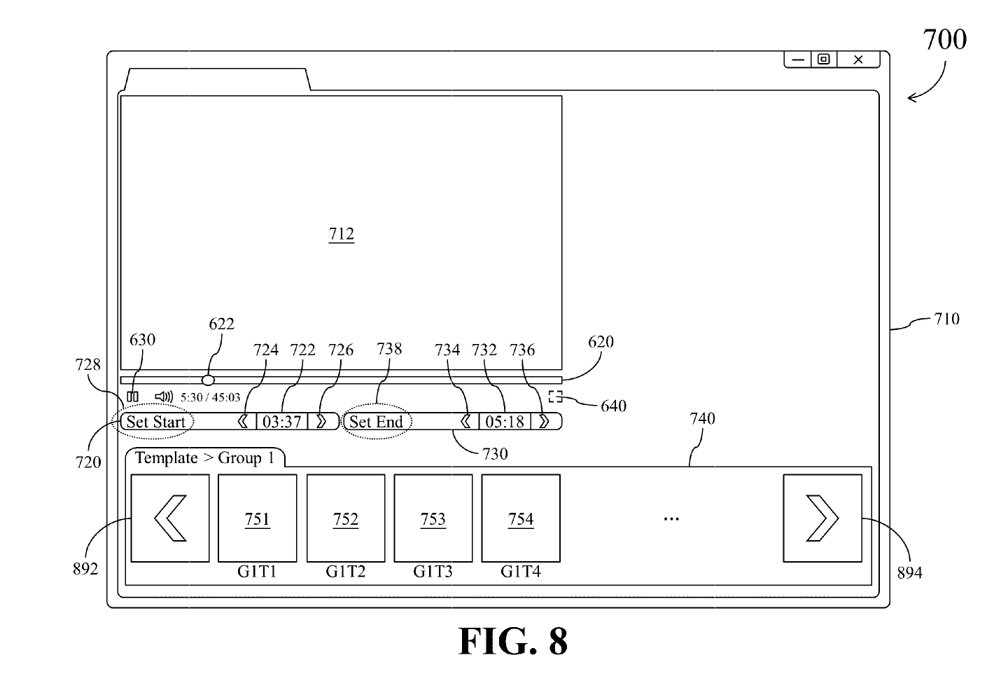

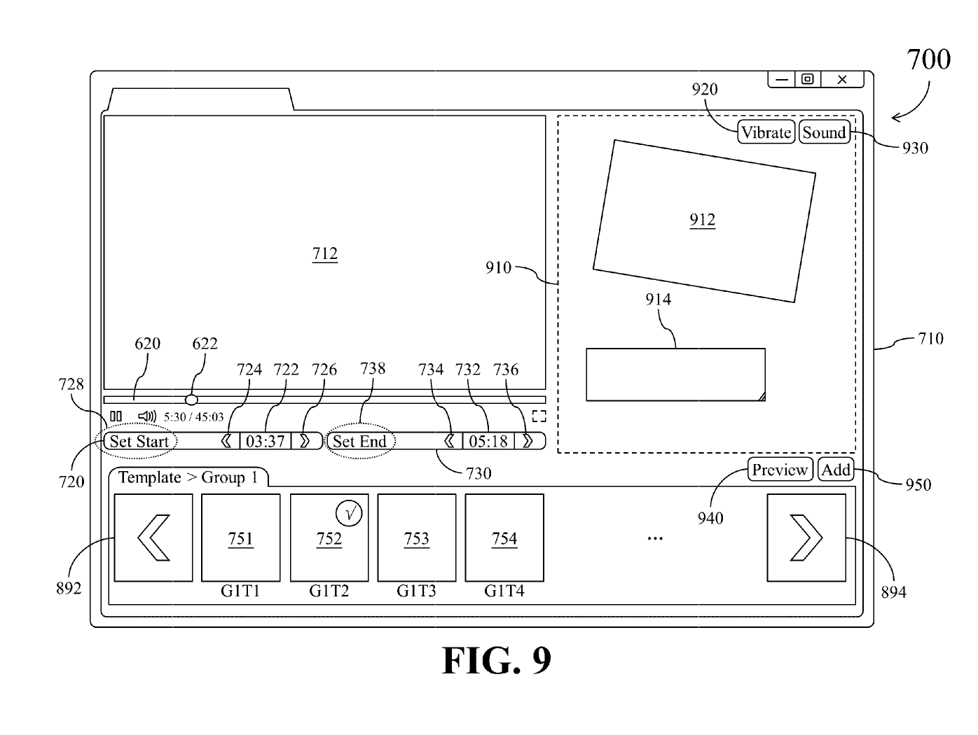

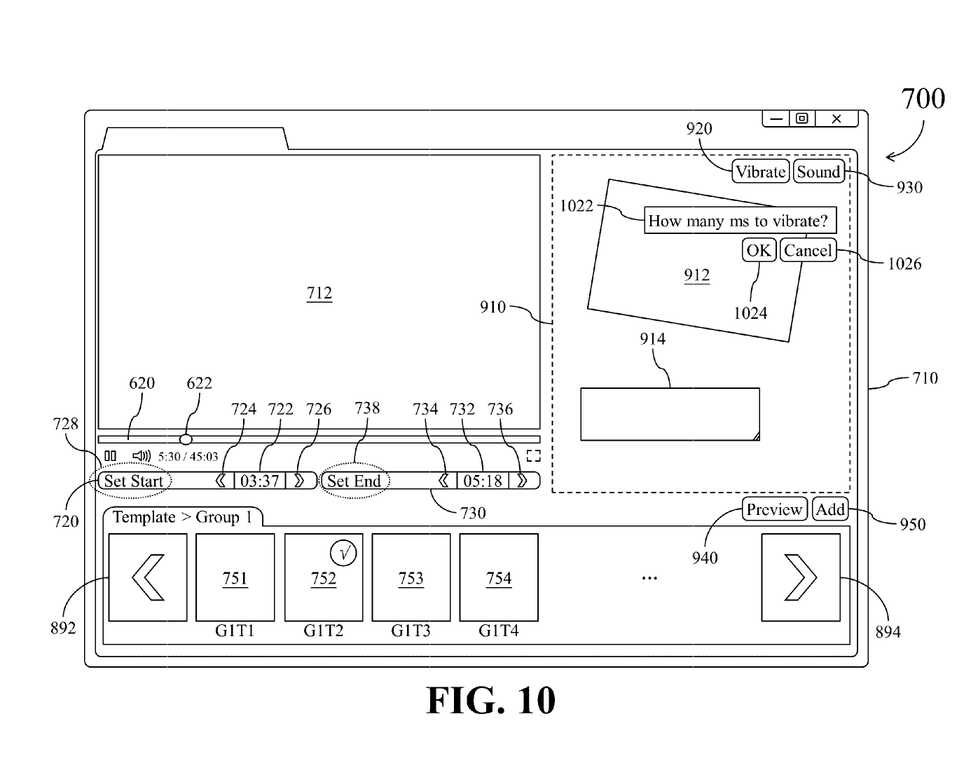

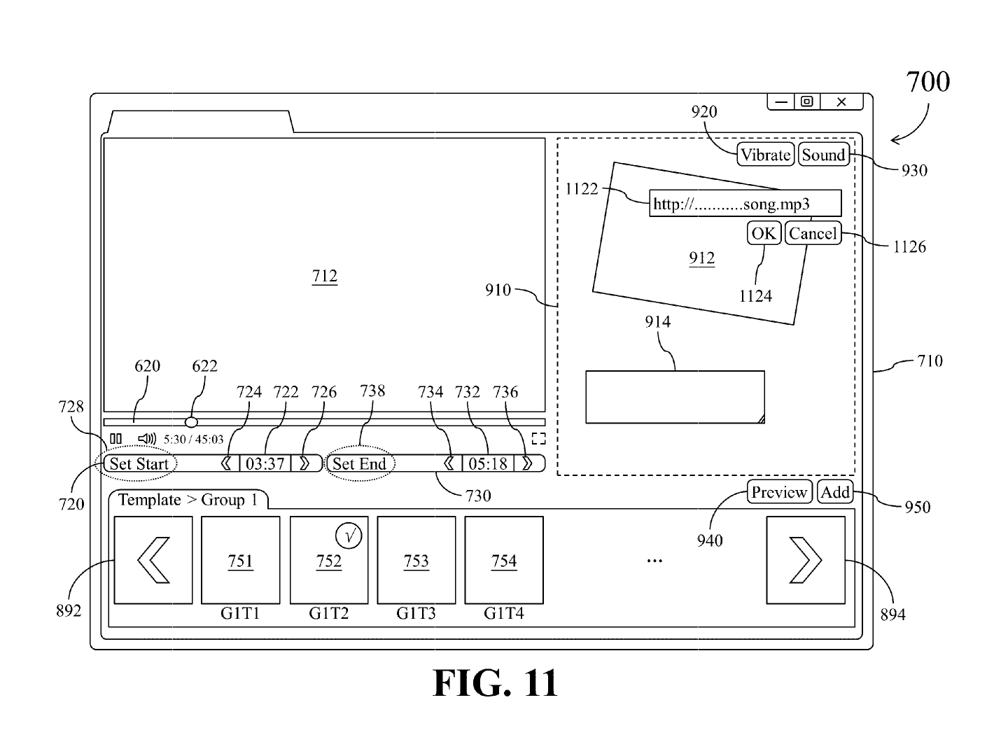

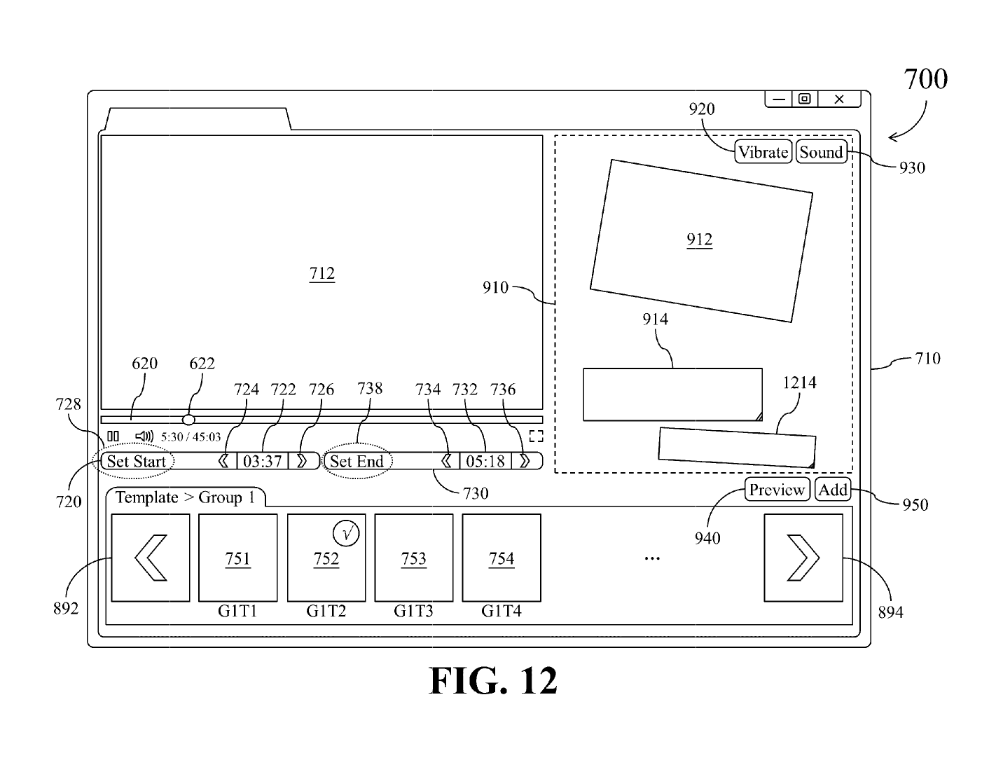

Then, the transmitting module 240 of the computer program product 127 performs the operation 402 of FIG. 4 to utilize the communication circuit 121 to receive the annotation editing page transmitted from the transmission circuit 112. At this moment, the display module 220 of the computer program product 127 utilizes the display device 122 to display the annotation editing page. For example, FIG. 7 shows a simplified schematic diagram of an annotation editing page 700 according to one embodiment of the present disclosure. The annotation editing page 700 comprises a display area 710. The display area 710 may be a window area of an application program (e.g., a web page browser).

The display module 220 may utilizes the display device 122 to display the target video in a partial region 712 within the display area 710, and to display the aforementioned progress bar 620, the play/pause key 630, and the full-screen-mode key 640 in the display area 710. The area of the partial region 712 in the annotation editing page 700 may be equal or different from the area of the aforementioned partial region 612 in the video playback page 600. Additionally, the display module 220 may further utilize the display device 122 to display a start time setting bar 720, an end time setting bar 730, and an annotation template selection area 740 in the display area 710.

In the embodiment of FIG. 7, the start time setting bar 720 comprises a start time displaying area 722, a backward key 724, a forward key 726, and a start time setting key 728. The end time setting bar 730 comprises an end time displaying area 732, a backward key 734, a forward key 736, and an end time setting key 738.

The display module 220 may utilize the display device 122 to display multiple annotation templates within the annotation editing page 700 in the annotation template selection area 740 for the user to select. In practice, the display module 220 may utilize the display device 122 to display all of the annotation templates within the annotation editing page 700 in the annotation template selection area 740 simultaneously.

Alternatively, the display module 220 may adopt a hierarchical presentation structure to present the annotation templates within the annotation editing page 700 in the annotation template selection area 740. For example, the display module 220 may categorize all the annotation templates within the annotation editing page 700 into different template groups, and utilize the display device 122 to display multiple template groups in the annotation template selection area 740 of the annotation editing page 700 for the user to select. In practice, different template groups may comprise different quantities of annotation templates.

If the display module 220 is not allowed to display all the template groups in the annotation template selection area 740 at the same time due to the area restriction of the annotation template selection area 740, the display module 220 may utilize the display device 122 to display a part of the template groups in the annotation template selection area 740, such as template groups 750, 760, 770, and 780 shown in FIG. 7, and to display a change-page key 790 in the annotation template selection area 740. When the user clicks the change-page key 790, the display module 220 may utilize the display device 122 to switch the template groups displayed in the annotation template selection area 740 to other combinations.

The display module 220 may utilize the display device 122 to display corresponding template group names aside different template groups to increase the user's ability of recognizing respective template group. As shown in FIG. 7, the display module 220 may utilize the display device 122 to display a corresponding template group name G1 aside the template group 750, to display a corresponding template group name G2 aside the template group 760, to display a corresponding template group name G3 aside the template group 770, and to display a corresponding template group name G4 aside the template group 780.

In addition to template group names, the display module 220 may further utilize the display device 122 to present representative images of some annotation templates of each template group in the corresponding display area of the template group, so as to increase the user's ability of recognizing the template group. The display module 220 may utilize various selection mechanisms to decide which annotation templates of each template group should be presented in the display area corresponding to the template group. For example, the display module 220 may present one or more annotation templates with higher sorting order within each template group in the corresponding display area of the template group, and may present one or more annotation templates recently added into each template group in the corresponding display area of the template group, or may present one or more most popular annotation templates within each template group in the corresponding display area of the template group.

For example, in the embodiment of FIG. 7, the display module 220 utilizes the display device 122 to present representative images of annotation templates 751, 752, 753, and 754 within the template group 750 in a corresponding display area of the template group 750. The display module 220 utilizes the display device 122 to present representative images of annotation templates 761, 762, 763, and 764 within the template group 760 in a corresponding display area of the template group 760. The display module 220 utilizes the display device 122 to present representative images of annotation templates 771, 772, and 773 within the template group 770 in a corresponding display area of the template group 770. The display module 220 utilizes the display device 122 to present representative images of annotation templates 781 and 782 within the template group 780 in a corresponding display area of the template group 780.

The user may select a target template group of the multiple template groups by clicking one of the multiple template groups displayed in the annotation template selection area 740. At this moment, the input device 124 receives a template group selection command corresponding to the target template group. For the convenience of illustration, it is herein assumed that the aforementioned target template group is the template group 750. When a template group selection command corresponding to the target template group 750 is received by the input device 124, the display module 220 utilizes the display device 122 to display multiple annotation templates corresponding to the target template group 750 in the annotation template selection area 740 of the annotation editing page 700.

If the display module 220 is not allowed to display all the annotation templates within the target template group 750 in the annotation template selection area 740 at the same time due to the area restriction of the annotation template selection area 740, the display module 220 may utilize the display device 122 to display a part of the annotation templates within the target template group 750 in the annotation template selection area 740. For example, as shown in FIG. 8, the display module 220 may utilize the display device 122 to display annotation templates 751, 752, 753, and 754 within the target template group 750 in the annotation template selection area 740, and to display change-page keys 892 and 894 in the annotation template selection area 740. When the user clicks the change-page key 892 or 894, the display module 220 may utilize the display device 122 to display other combinations of the annotation templates within the target template group 750 in the annotation template selection area 740.

The display module 220 may utilize the display device 122 to display corresponding annotation template names aside different annotation templates to increase the user's ability of recognizing respective annotation template. For example, in the embodiment of FIG. 8, the display module 220 utilizes the display device 122 to display a corresponding annotation template name G1T1 aside the annotation template 751, to display a corresponding annotation template name G1T2 aside the annotation template 760, to display a corresponding annotation template name G1T3 aside the annotation template 770, and to display a corresponding annotation template name G1T4 aside the annotation template 780.

The user may select a target annotation template of the multiple annotation templates by clicking one of the multiple annotation templates displayed in the annotation template selection area 740. At this moment, the input device 124 performs the operation 404 to receive an annotation template selection command corresponding to the target annotation template. For the convenience of illustration, it is herein assumed that the target annotation template is the annotation template 752 within the target template group 750.

When an annotation template selection command corresponding to the annotation template 752 is received by the input device 124, the display module 220 performs the operation 406 to utilize the display device 122 to display a preview of the target annotation template 752 in an annotation preview area of the annotation editing page 700.

For example, as shown in FIG. 9, the display module 220 may utilize the display device 122 to display an annotation preview area 910 in the annotation editing page 700, and to display the preview of the target annotation template 752 in the annotation preview area 910. The display module 220 may further utilize the display device 122 to display a vibration setting key 920, a sound setting key 930, a preview key 940, and a confirmation key 950 in the annotation editing page 700.

In the embodiment of FIG. 9, an object 912 and a text frame 914 displayed in the annotation preview area 910 represent main components of the target annotation template 752. The object 912 may be an animation, a static picture, or a graph. The user may manipulate the input device 124 to perform operations such as dragging, rotating, moving, scaling, and/or boundary adjustment for a specific object in the annotation preview area 910. At this moment, the setting module 230 of the computer program product 127 performs the operation 408 to modify parameters of the target annotation template 752 according to the user's manipulation to the input device 124.

Then, the display module 220 performs the operation 410 to utilize the display device 122 to display a modified preview of the target annotation template 752 in the annotation preview area 910 for the user to acknowledge.

For example, when the user modifies a shape, a position, a size, and/or a rotation angle of the object 912, the setting module 230 modifies parameters such as the shape, the position, the size, and/or the rotation angle of the object 912 correspondingly, and the display module 220 controls the display device 122 to display the modified result of the shape, the position, the size, and/or the rotation angle of the object 912 in the annotation preview area 910. When the user modifies a shape, a position, a size, and/or a rotation angle of the text frame 914, the setting module 230 modifies parameters such as the shape, the position, the size, and/or the rotation angle of the text frame 914 correspondingly, and the display module 220 controls the display device 122 to display the modified result of the shape, the position, the size, and/or the rotation angle of the text frame 914 in the annotation preview area 910.

In one embodiment, when the user performs a specific manipulation to the input device 124, the display module 220 further controls the display device 122 to display a parameter setting menu (not shown) in the annotation editing page 700 for the user to modify a part of the parameters of the target annotation template 752. For example, when the user clicks the object 912 or the text frame 914 through the input device 124 for multiple times, the display module 220 may control the display device 122 to display the parameter setting menu in the annotation editing page 700. In the embodiment where the input device 124 is a computer mouse, when the user pushes the right key of the computer mouse, the display module 220 may control the display device 122 to display the parameter setting menu in the annotation editing page 700.

The user may configure the content of the aforementioned parameter setting menu through the input device 124 to modify a color, a moving direction, a moving speed, a moving path, and/or a lasting time on the screen of the object 912, and to modify a color, a moving direction, a moving speed, a moving path, and/or a lasting time on the screen of the text frame 914 in the same way. As described previously, the setting module 230 correspondingly modifies related parameters of the object 912 and/or the text frame 914, and the display module 220 utilizes the display device 122 to display the modified result of the object 912 and/or the text frame 914 in the annotation preview area 910. In the embodiment where the object 912 is an animation, the user may configure the content of the aforementioned parameter setting menu through the input device 124 to modify an animation change speed of the object 912.

As shown in FIG. 10, when the user clicks the vibration setting key 920 in the annotation editing page 700, the display module 220 utilizes the display device 122 to display a vibration-lasting-time setting field 1022, a confirmation key 1024, and a cancel key 1026 in the annotation editing page 700. At this moment, the user may input a time length value into the vibration-lasting-time setting field 1022 to configure a lasting time of vibration of the object 912 or the target annotation template 752. The unit time length corresponding to the above time length value may be configured by the designer of the computer program product 127 as needed. For example, in one embodiment, when the above time length value is 5, it means that the lasting time of vibration of the object 912 or the target annotation template 752 is 5 seconds. In another embodiment, when the above time length value is 5, it means that the lasting time of vibration of the object 912 or the target annotation template 752 is 5 minutes.

Afterward, when the user clicks the confirmation key 1024 in the annotation editing page 700, the setting module 230 records the parameter of the lasting time of vibration of the object 912 or the annotation template 752. When the user clicks the cancel key 1026 in the annotation editing page 700, the setting module 230 discards the parameter of the lasting time of vibration of the object 912 or the target annotation template 752 configured by the user.

As shown in FIG. 11, when the user clicks the sound setting key 930 in the annotation editing page 700, the display module 220 utilizes the display device 122 to display a sound file location setting field 1122, a confirmation key 1124, and a cancel key 1126 in the annotation editing page 700. At this moment, the user may input a location configuration of an audio file, such as a URL address or a local storage location, into the sound file location setting field 1122.

Afterward, when the user clicks the confirmation key 1124 in the annotation editing page 700, the setting module 230 retrieves the aforementioned audio file. When the user clicks the cancel key 1126 in the annotation editing page 700, the setting module 230 discards the related settings of the aforementioned audio file configured by the user.

In addition to change the shape, the position, the size, and/or the rotation angle of the text frame in the target annotation template 752, the user is also allowed to change the quantity of text frames in the annotation template 752. For example, as shown in FIG. 12, the user may issue a duplication command through the input device 124 to duplicate the text frame 914 to generate another text frame 1214. Similarly, the user may modify a shape, a position, a size, a rotation angle, a color, a moving direction, a moving speed, a moving path, and/or a lasting time on the screen of the text frame 1214 using the aforementioned approaches.

When the user clicks the preview key 940 in the annotation editing page 700, the display module 220 utilizes the display device 122 to display the modified review of the target annotation template 752 in the annotation preview area 910 to reflect the modified parameters of the target annotation template 752 for the user to acknowledge.

In practice, the user may utilize the webpage display device 120 to repeatedly perform the aforementioned operations 408 and 410 until the user is satisfied with the modified result of the target annotation template 752.

As describe previously, the display module 220 utilizes the display device 122 to display the start time setting bar 720 and the end time setting bar 730 in the display area 710. The user is allowed to utilize the start time setting bar 720 to set a start time of a multimedia annotation, and to utilize the end time setting bar 730 to set an end time of the multimedia annotation.

For example, the user is allowed to input a start time value into the start time displaying area 722 through the input device 124, and is allowed to utilize the backward key 724 and the forward key 726 to fine tune the start time value. When the user pushes the start time setting key 728, the setting module 230 performs the operation 412 to configure the start time of the multimedia annotation according to the user's manipulation.

Alternatively, the user may push the start time setting key 728 when the target video is played to a specific time point. At this moment, the setting module 230 performs the operation 412 to configure the start time of the multimedia annotation according to the user's manipulation.

Similarly, the user is allowed to input an end time value into the end time displaying area 732 through the input device 124, and is allowed to utilize the backward key 734 and the forward key 736 to fine tune the end time value. When the user pushes the end time setting key 738, the setting module 230 performs the operation 412 to configure the end time of the multimedia annotation according to the user's manipulation.

Alternatively, the user may push the end time setting key 738 when the target video is played to a specific time point. At this moment, the setting module 230 performs the operation 412 to configure the end time of the multimedia annotation according to the user's manipulation.

In the operation 414, the setting module 230 configures an accessing right of the multimedia annotation. In practice, the setting module 230 may configure the accessing right of the multimedia annotation according to the user's manipulation to the input device 124. Alternatively, the setting module 230 may configure the accessing right of the multimedia annotation according to default rules.

In the operation 416, the transmitting module 240 of the computer program product 127 utilizes the communication circuit 121 to transmit the start time, the end time, the modified parameters of the target annotation template 752, and the accessing right to the web server 110 through the internet 130.

In the operation 418, the transmission circuit 112 of the web server 110 receives the start time, the end time, the modified parameters of the target annotation template 752, and the accessing right transmitted from the webpage display device 120.

In the operation 420, the processing circuit 114 generates the multimedia annotation according to the modified parameters of the target annotation template 752. In practical applications, the multimedia annotation may be an advertisement, supplementary information, detailed introduction, relevant instruction, user comment related to the target video, or the like.

In the operation 422, the processing circuit 114 establishes a timing correlation between the multimedia annotation and the target video according to the start time and the end time.

In the operation 424, the processing circuit 114 stores the multimedia annotation, the accessing right of the multimedia annotation, and the timing correlation between the multimedia annotation and the target video into the data base 116.

Afterward, when a second user, who has the accessing right of the multimedia annotation, utilizes a second webpage display device (not shown) to request the web server 110 to play the target video, the web server 110 not only provides the playback page of the target video to the second webpage display device, but also transmits the multimedia annotation to the second webpage display device. As a result, the second webpage display device is enabled to synchronously display the multimedia annotation in a period between the start time and the end time while displays the target video.

In practical applications, when the second user wants to utilize the second webpage display device to display the target video while utilizes a third webpage display device (not shown) to display the multimedia annotation, the web server 110 may transmit the multimedia annotation to the third webpage display device so that the third webpage display device is enabled to synchronously display the multimedia annotation in a period between the start time and the end time while the second webpage display device displays the target video.

Since the aforementioned multimedia annotation has much richer content for presentation than the traditional text annotation, the multimedia annotation is thus able to attract more attention of the second user, thereby improving the degree of interaction between different users.

In the previous embodiments, the annotation preview area 910 and the partial region 712 for displaying the target video are not overlapped with each other, but this is merely an exemplary example rather than a restriction to the practical implementations. In practice, the display module 220 may utilize the display device 122 to respectively display the annotation preview area 910 and the partial region 712 on different layers of the annotation editing page 700, and overlaps with the annotation preview area 910 with a portion or an entirety of the partial region 712.

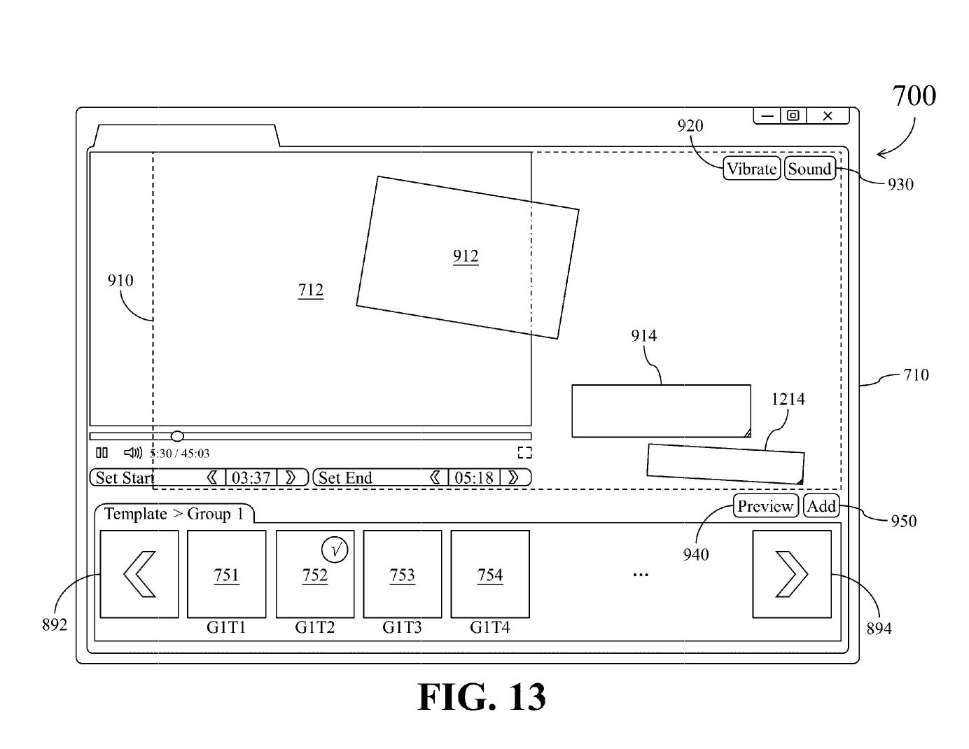

For example, in the embodiment of FIG. 13, the display module 220 may utilize the display device 122 to display the partial region 712 on a first layer of the annotation editing page 700, and to display the annotation preview area 910 on a second layer higher than the first layer (i.e., the second layer is closer to the user eyes than the first layer in terms of the visual effect) to create a visual effect where the annotation preview area 910 is overlapped with a portion of the partial region 712.

Since the annotation preview area 910 is overlapped with the partial region 712, the user is allowed to modify the position, the rotation angle, the moving direction, and/or the moving path of the object 912, the text frame 914, or the text frame 1214 in the way described previously to put the object 912, the text frame 914, or the text frame 1214 to enter the scope of the partial region 712. For example, as shown in FIG. 13, the user is allowed to modify the position of the object 912 in the way described previously to make the object 912 to enter the scope of the partial region 712. Similarly, the user is allowed to modify the position of the text frame 914 or the text frame 1214 in the way described previously to make the text frame 914 or the text frame 1214 to enter the scope of the partial region 712. The setting module 230 may further record the relative position between the annotation preview area 910 and the partial region 712, the relative position between the object 912 and the partial region 712, the relative position between the text frame 914 and the partial region 712, or the relative position between the text frame 1214 and the partial region 712 as a part of the modified parameters of the target annotation template 752. In this way, the information of the above relative positions would be transmitted from the transmitting module 240 to the web server 110 through the communication circuit 121 for storage.

As a result, in the aforementioned embodiment where the second webpage display device is utilized to display the target video and to synchronously display the multimedia annotation, the second webpage display device is enabled to create a visual effect for presenting interaction between some objects in the multimedia annotation (e.g., the object 912, the text frame 914, or the text frame 1214) and the content of the target video. For example, a visual effect for presenting that the object 912 is moving from the display area of the multimedia annotation to the display area of the target video could be created in this way. Similarly, in the aforementioned embodiment where the second webpage display device is utilized to display the target video, and the third webpage display device is utilized to synchronously display the multimedia annotation, a visual effect for presenting interaction between some objects displayed by the third webpage display device (e.g., the object 912, the text frame 914, or the text frame 1214) and the video content of the target video displayed by the second webpage display device could be created accordingly. For example, a visual effect for presenting that the object 912 is moving from the display area of the third webpage display device to the display area of the second webpage display device could be created in the way described previously.

Please note that the aforementioned executing order of the operations in FIG. 3 and FIG. 4 is merely an exemplary embodiment rather than a restriction to the practical implementations of the invention. For example, the operation 318 may be performed at the same time as the operation 316 or 314. In addition, the operations 412 and 414 may be swapped, and the operation 412 and the operation 414 may be adjusted to be before the operation 404, 406, or 408.

In addition, the computer program product 127 stored in the memory 126 of the webpage display device 120 may be an application program or a plug-in downloaded from other servers by the webpage display device 120 in advance through the internet 130 and pre-installed in the webpage display device 120.

Alternatively, the computer program product 127 may be provided to the webpage display device 120 from the web server 110. For example, when the webpage display device 120 requests the web server 110 to provide the video playback page or the annotation editing page, the web server 110 may embed the computer program product 127 into the video playback page or the annotation editing page, and transmit the computer program product 127 to the webpage display device 120 along with the video playback page or the annotation editing page. That is, the web server 110 may transmit the computer program product 127 to the webpage display device 120 in the aforementioned operation 312 or 324.

As can be appreciated from the foregoing descriptions, the user is enabled to easily create a multimedia annotation corresponding to one or more characters, articles, sounds, scenes, stories, locations, or time appearing in a certain period of the target video by utilizing the webpage display device 120 to select a target annotation template and modify the parameters of the target annotation template, without purchasing additional multimedia editing software or receiving professional training on multimedia content producing. Accordingly, the proposed multimedia annotation editing system 100 is capable of greatly increasing the convenience for the user in producing multimedia annotations, thereby effectively increasing the degree of interaction between different users.

In addition, since the annotation templates in the annotation editing page 700 could be fully tested for compatibility of their contents in advance, the cross-platform compatibility of the multimedia annotation created by the user with the multimedia annotation editing system 100 could be effectively improved.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A multimedia annotation editing system, comprising:
a web server, configured to operably provide an annotation editing page comprising multiple annotation templates; and
a webpage display device, configured to operably communicate with the web server through an internet, and to operably receive and display the annotation editing page transmitted from the web server through the internet;
wherein when the webpage display device displays the annotation editing page, if an annotation template selection command corresponding to a target annotation template of the multiple annotation templates is received by the webpage display device, the webpage display device displays a preview of the target annotation template in an annotation preview area of the annotation editing page;
wherein the webpage display device further modifies at least one of following parameters of the target annotation template according to a user's manipulation:
a quantity of text frames in the target annotation template;
a size of a text frame in the target annotation template;
a position of a text frame in the target annotation template;
a shape of an object in the target annotation template;
a position of an object in the target annotation template;
a size of an object in the target annotation template;
a rotation angle of an object in the target annotation template;
a color of an object in the target annotation template;
a lasting time on the screen of an object in the target annotation template;
a moving speed of an object in the target annotation template;
a moving direction of an object in the target annotation template;
a moving path of an object in the target annotation template;
a change speed of an animation in the target annotation template;
a lasting time of vibration of an object in the target annotation template; and
a lasting time of vibration of the target annotation template;
wherein the webpage display device displays a modified preview of the target annotation template in the annotation preview area, and configures a start time and an end time of a multimedia annotation according to the user's manipulation;
wherein the webpage display device transmits the start time, the end time, and modified parameters of the target annotation template to the web server, the web server generates the multimedia annotation according to the modified parameters of the target annotation template, and establishes and stores a timing correlation between the multimedia annotation and a target video according to the start time and the end time.

2. The multimedia annotation editing system of claim 1, wherein the web server comprises:
a transmission circuit, configured to operably transmit the annotation editing page to the webpage display device through the internet, and to operably receive the start time, the end time, and the modified parameters of the target annotation template transmitted from the webpage display device;
a processing circuit, coupled with the transmission circuit, configured to operably control operations of the transmission circuit, to operably generate the multimedia annotation according to the modified parameters of the target annotation template, and to operably establish timing correlation between the multimedia annotation and the target video according to the start time and the end time; and
a data base, coupled with the processing circuit, configured to operably store the multimedia annotation and the timing correlation between the multimedia annotation and the target video;
wherein the webpage display device comprises:
a communication circuit, configured to operably receive the annotation editing page transmitted from the transmission circuit;
a display device, configured to operably display the annotation editing page;
a speaker;
an input device, configured to operably receive the annotation template selection command; and
a control circuit, coupled with the communication circuit, the display device, the speaker, and the input device, wherein when the display device displays the annotation editing page, if the annotation template selection command is received by the input device, then the control circuit controls the display device to display the preview of the target annotation template in the annotation preview area of the annotation editing page;
wherein the control circuit further modifies the parameters of the target annotation template and configures the start time and the end time of the multimedia annotation according to the user's manipulation to the input device, and controls the display device to display the modified preview of the target annotation template in the annotation preview area;
wherein the control circuit further controls the communication circuit to transmit the start time, the end time, and the modified parameters of the target annotation template to the transmission circuit.

3. The multimedia annotation editing system of claim 2, wherein the control circuit further controls the display device to display multiple template groups in the annotation editing page, and when a template group selection command corresponding to a target template group of the multiple template groups is received by the input device, the control circuit controls the display device to display the multiple annotation templates corresponding to the target template group in the annotation editing page.

4. The multimedia annotation editing system of claim 3, wherein the control circuit further utilizes the communication circuit to transmit an editing page request to the transmission circuit, so as to request the web server to provide the annotation editing page.

5. The multimedia annotation editing system of claim 2, wherein the control circuit further utilizes the display device to display the target video in a partial region of the annotation editing page, and the annotation preview area overlaps with a portion or an entirety of the partial region.

6. The multimedia annotation editing system of claim 5, wherein the control circuit further records a relative position between the annotation preview area and the partial region or records a relative position between the partial region and an object in the annotation preview area as a part of the modified parameters of the target annotation template.

7. A multimedia annotation editing method for use in a multimedia annotation editing system, wherein the multimedia annotation editing system comprises a web server and a webpage display device, and the webpage display device comprises a communication circuit, a display device, a speaker, an input device, and a control circuit, the method comprising:
utilizing the communication circuit to receive an annotation editing page comprising multiple annotation templates transmitted from the transmission circuit through an internet;
utilizing the display device to display the annotation editing page;
when the display device displays the annotation editing page, utilizing the display device to display a preview of a target annotation template of the multiple annotation templates in an annotation preview area of the annotation editing page if an annotation template selection command corresponding to the target annotation template is received by the input device;
modifying at least one of following parameters of the target annotation template according to a user's manipulation to the input device:
a quantity of text frames in the target annotation template;
a size of a text frame in the target annotation template;
a position of a text frame in the target annotation template;
a shape of an object in the target annotation template;
a position of an object in the target annotation template;
a size of an object in the target annotation template;
a rotation angle of an object in the target annotation template;
a color of an object in the target annotation template;
a lasting time on the screen of an object in the target annotation template;
a moving speed of an object in the target annotation template;
a moving direction of an object in the target annotation template;
a moving path of an object in the target annotation template;
a change speed of an animation in the target annotation template;
a lasting time of vibration of an object in the target annotation template; and
a lasting time of vibration of the target annotation template;
utilizing the display device to display a modified preview of the target annotation template in the annotation preview area;
configuring a start time and an end time of a multimedia annotation according to the user's manipulation to the input device; and
utilizing the communication circuit to transmit the start time, the end time, and modified parameters of the target annotation template to the web server, so that the web server generates the multimedia annotation according to the modified parameters of the target annotation template and establishes and stores a timing correlation between the multimedia annotation and a target video according to the start time and the end time.

8. The method of claim 7, further comprising:
utilizing the display device to display multiple template groups in the annotation editing page; and
when a template group selection command corresponding to a target template group of the multiple annotation templates is received by the input device, utilizing the display device to display the multiple annotation templates corresponding to the target template group in the annotation editing page.

9. A computer program product, stored in a non-transitory storage device of a webpage display device in a multimedia annotation editing system, when executed by a control circuit of the webpage display device, enabling the webpage display device to perform a multimedia annotation editing operation, wherein the multimedia annotation editing system comprises a web server and the webpage display device, and the webpage display device comprises a communication circuit, a display device, a speaker, an input device, and the control circuit, the computer program product comprising:
a receiving module, for utilizing the communication circuit to receive an annotation editing page comprising multiple annotation templates transmitted from the web server through an internet;
a display module, for utilizing the display device to display the annotation editing page;
a setting module; and
a transmitting module;
wherein when the display device displays the annotation editing page, if an annotation template selection command corresponding to a target annotation template of the multiple annotation templates is received by the input device, the display module utilizes the display device to display a preview of the target annotation template in an annotation preview area of the annotation editing page;
wherein the setting module further modifies at least one of following parameters of the target annotation template according to a user's manipulation to the input device:
a quantity of text frames in the target annotation template;
a size of a text frame in the target annotation template;
a position of a text frame in the target annotation template;
a shape of an object in the target annotation template;
a position of an object in the target annotation template;
a size of an object in the target annotation template;
a rotation angle of an object in the target annotation template;
a color of an object in the target annotation template;
a lasting time on the screen of an object in the target annotation template;
a moving speed of an object in the target annotation template;
a moving direction of an object in the target annotation template;
a moving path of an object in the target annotation template;
a change speed of an animation in the target annotation template;
a lasting time of vibration of an object in the target annotation template; and
a lasting time of vibration of the target annotation template;
wherein the display module utilizes the display device to display a modified preview of the target annotation template in the annotation preview area, and the setting module configures a start time and an end time of a multimedia annotation according to the user's manipulation to the input device;
wherein the transmitting module utilizes the communication circuit to transmit the start time, the end time, and modified parameters of the target annotation template to the web server, so that the web server generates the multimedia annotation according to the modified parameters of the target annotation template and establishes and stores a timing correlation between the multimedia annotation and a target video according to the start time and the end time.

10. The computer program product of claim 9, wherein the display module further utilizes the display device to display multiple template groups in the annotation editing page, and when a template group selection command corresponding to a target template group of the multiple template groups is received by the input device, the display module utilizes the display device to display the multiple annotation templates corresponding to the target template group in the annotation editing page.

11. The computer program product of claim 10, wherein the transmitting module further utilizes the communication circuit to transmit an editing page request to the web server, so as to request the web server to provide the annotation editing page.

12. The computer program product of claim 11, wherein the computer program product is transmitted along with the annotation editing page to the webpage display device from the web server.

13. The computer program product of claim 9, wherein the display module further utilizes the display device to display the target video in a partial region of the annotation editing page, and the annotation preview area overlaps with a portion or an entirety of the partial region.

14. The computer program product of claim 13, wherein the setting module further records a relative position between the annotation preview area and the partial region or records a relative position between the partial region and an object in the annotation preview area as a part of the modified parameters of the target annotation template.
